(19) United States
(12) Patent Application Publication
(10) Pub. No.: US 2014/0328155 A1
(43) Pub. Date: Nov. 6, 2014

(54) INCREASED INFORMATION CARRYING CAPACITY IN AN ENHANCED GENERAL PACKET RADIO SERVICE CONTROL CHANNEL

(71) Applicant: QUALCOMM Incorporated, San Diego, CA (US)

(72) Inventors: Mungal Singh Dhanda, Slough (GB); Zhi-Zhong Yu, Reading (GB); Awnit Kumar, Reading (GB)

(73) Assignee: QUALCOMM Incorporated, San Diego, CA (US)

(21) Appl. No.: 14/265,866

(22) Filed: Apr. 30, 2014

Related U.S. Application Data
(60) Provisional application No. 61/818,413, filed on May 1, 2013.

(51) Int. Cl. H04L 1/00

(52) U.S. Cl. CPC H04L 1/0003
USPC 370/215; 370/329

(57) ABSTRACT

Systems and methods for selecting modulation and encoding schemes for transmitting control information on a wireless channel. For example, a base station or access terminal may select a modulation and coding scheme for transmitting radio link or media access control messages on a radio frequency channel based on a link quality of the radio frequency channel. The radio frequency channel may be an enhanced general packet radio service control channel. Other aspects, embodiments, and features are also claimed and described.

### CROSS-REFERENCE TO RELATED APPLICATIONS

This application claims priority to and the benefit of provisional patent application No. 61/818,413 filed in the United States Patent Office on May 1, 2013, the entire content of which is incorporated herein by reference as if fully set forth below and for all applicable purposes.

### TECHNICAL FIELD

The technology discussed below generally relates to wireless communication, and more specifically to methods and devices for communicating control messages through a wireless network. Aspects of the technology can aid in enabling high carrying capacity on communication channels, which can aid in network performance and efficiently use of power resources for communication devices, such as mobile devices.

### BACKGROUND

Wireless communications systems are widely deployed to provide various types of communication content such as voice, video, packet data, messaging, broadcast, and so on. These systems may be accessed by various types of access terminals adapted to facilitate wireless communications, where multiple access terminals share the available system resources (e.g., time, frequency, and power). Examples of such wireless communications systems include code-division multiple access (CDMA) systems, time-division multiple access (TDMA) systems, frequency-division multiple access (FDMA) systems and orthogonal frequency-division multiple access (OFDMA) systems.

Access terminals adapted to access one or more wireless communications systems are becoming increasingly popular and more functionally complex. Access terminals are experiencing increased bandwidth requirements for control information as the number and complexity of deployed networks increases.

### BRIEF SUMMARY OF SOME EXAMPLES

Various features and aspects of the present disclosure can facilitate selection of modulation and coding schemes that can provide increased bandwidth for transmission of control messages on a wireless link. Control information exchanged in Radio Link Control (RLC) and/or media access control (MAC) messages may be transmitted using channel coding schemes that provide increased payload capacities than the default channel coding scheme conventionally specified for RLC and MAC messages. According to certain aspects disclosed herein, higher bandwidth channel coding schemes may be selected for transmitting control information when channel conditions permit. Increases in bandwidth available for transmitting control information may be increased by at least 79% and by up to 530% or more. In one example, quadrature phase-shift keying (QPSK) may be employed in accordance with certain aspects disclosed herein in order to double the bandwidth provided when Gaussian minimum-shift keying (GMSK) is used for transmitting RLC and MAC messages.

In an aspect of the disclosure, a base station has a communications interface that includes a receiver circuit, a storage medium, and a processing circuit coupled to the communications interface and the storage medium. The processing circuit may be adapted to receive measurements of one or more attributes of an radio frequency (RF) channel from another communications device, select a first modulation scheme based on the measurements, and transmit one or more downlink RLC or downlink MAC messages over the RF channel to the access terminal using the first modulation scheme.

In one aspect, a second modulation scheme is selected based on the measurements. The second modulation scheme may be used for transmitting user data over the RF channel. The first modulation scheme may provide a lower transmission bit rate than the second modulation scheme.

In one aspect, the processing circuit is adapted to select the first modulation scheme based on a link quality of the RF channel determined by comparing the measurements to a first set of threshold values, and select a second modulation scheme based on a link quality of the RF channel determined by comparing the measurements to a second set of threshold values that is different from the first set of threshold values. The second modulation scheme may be used for transmitting user data over the RF channel. The first set of threshold values and the second set of threshold values may define different maximum permissible Signal to Interference plus Noise Ratios (SINRs), different minimum available transmitter powers, or different maximum permissible path losses.

In one aspect, the processing circuit may be adapted to determine a link quality of the RF channel based on the measurements, select the first modulation scheme by comparing the link quality to a first set of criteria, and select a second modulation scheme by comparing the link quality to a second set of criteria that is different from the first set of criteria. The second modulation scheme may be used for transmitting user data over the RF channel. The first set of criteria and the second set of criteria may relate to a maximum permissible SINR, a minimum available transmitter power, or a maximum permissible path loss.

In one aspect, the processing circuit may be adapted to determine a link quality of the RF channel based on the measurements, select a second modulation scheme based on the link quality, select a modulation scheme that provides a lower data-rate than the second modulation scheme as the first modulation scheme when the second modulation scheme does not provide a lowest available data-rate for transmitting information over the RF channel, and select a modulation scheme that provides a same data-rate as the second modulation scheme to be the first modulation scheme when the second modulation scheme provides the lowest available data-rate for transmitting information over the RF channel. The second modulation scheme may provide a best available data-rate for transmitting information over the RF channel. The second modulation scheme may be used for transmitting user data over the RF channel.

In one aspect, the first modulation scheme employs a PSK modulation scheme. The first modulation scheme may be different from a default modulation scheme defined for encoding the one or more downlink RLC or downlink MAC messages.

In one aspect, the first modulation scheme is selected to obtain a desired payload size for at least one downlink RLC or downlink MAC message. The desired payload size may be optimized when padding of the payload is minimized.

In one aspect, the processing circuit is adapted to identify a third modulation scheme that is used by an access terminal to encode an uplink RLC message or an uplink MAC message. The access terminal may decode the uplink RLC message or the uplink MAC message based on the identification of the third modulation scheme. The third modulation scheme may be identified from a symbol rotation in a training sequence preceding the uplink RLC message or the uplink MAC message.

In an aspect of the disclosure, a method for data communication performed by a base station includes receiving measurements of one or more attributes of an RF channel from another communications device, selecting a first modulation scheme based on the measurements, and transmitting one or more downlink RLC or downlink MAC messages over the RF channel using the first modulation scheme.

In one aspect, a second modulation scheme is selected based on the measurements. The second modulation scheme is different from the first modulation scheme and may provide a best available data-rate for transmitting information over the RF channel. User data may be transmitted over the RF channel using the second modulation scheme. The first modulation scheme may provide a lower transmission bit rate than the second modulation scheme.

In one aspect, a third modulation scheme is identified, where the third modulation scheme is used by an access terminal to encode an uplink RLC message or an uplink MAC message. The uplink RLC message or the uplink MAC message may be decoded based on the identification of the third modulation scheme. The third modulation scheme may be identified from a symbol rotation in a training sequence preceding the uplink RLC message or the uplink MAC message.

In an aspect of the disclosure, an access terminal may have a communications interface that includes a receiver circuit, a storage medium, and a processing circuit coupled to the communications interface and the storage medium. The processing circuit may be adapted or configured to cause the receiver circuit to obtain measurements of one or more RF characteristics of an RF channel, transmit the measurements to another communications device, determine a first modulation scheme to be used to encode an uplink RLC message or an uplink MAC message for transmission on the RF channel based on the measurements, and transmit the RLC message or the MAC message over the RF channel using the first modulation scheme.

In one aspect, the first modulation scheme is different from a second modulation scheme that is used to encode user data transmitted over the RF channel. The first modulation scheme may be a phase-shift keying modulation scheme. The first modulation scheme may be different from a default modulation scheme defined for encoding the RLC message or the MAC message.

In one aspect, the processing circuit may be adapted to select the first modulation scheme based on a link quality of the RF channel determined by comparing the measurements to a first set of threshold values, and select a second modulation scheme based on a link quality of the RF channel determined by comparing the measurements to a second set of threshold values that is different from the first set of threshold values. The second modulation scheme may be used for transmitting user data over the RF channel. The first set of threshold values and the second set of threshold values may define different maximum permissible SINRs, different minimum available transmitter powers, or different maximum permissible path losses.

In one aspect, the processing circuit may be adapted to determine a link quality of the RF channel based on the measurements, select the first modulation scheme by comparing the link quality to a first set of criteria, and select a second modulation scheme by comparing the link quality to a second set of criteria that is different from the first set of criteria. The second modulation scheme may be used for transmitting user data over the RF channel. The first set of criteria and the second set of criteria may relate to a maximum permissible SINR, a minimum available transmitter power, or a maximum permissible path loss.

In one aspect, the first modulation scheme is selected to obtain an optimized payload size of at least one uplink RLC or uplink MAC message. The payload size may be optimized when padding of the payload is minimized.

In one aspect, the processing circuit is adapted to identify a third modulation scheme that is used by a base station to encode a downlink RLC message or a downlink MAC message, and decode the downlink RLC message or the downlink MAC message based on identification of the third modulation scheme. The third modulation scheme may be identified from a symbol rotation in a training sequence preceding the downlink RLC message or the downlink MAC message.

In an aspect of the disclosure, a method for data communication performed by an access terminal includes obtaining measurements of one or more RF characteristics of an RF channel, selecting a first modulation scheme based on the measurements, selecting a second modulation scheme based on the measurements, and transmitting one or more uplink RLC or uplink MAC messages over the RF channel using the second modulation scheme. The second modulation scheme may be different from the first modulation scheme. The first modulation scheme may provide a best available data-rate for transmitting information over the RF channel.

In one aspect, a third modulation scheme may be identified, where the third modulation scheme may be used by a base station to encode a downlink RLC message or a downlink MAC message. The downlink RLC message or the downlink MAC message may be decoded based on the identification of the third modulation scheme. The third modulation scheme may be identified from a symbol rotation in a training sequence preceding the downlink RLC message or the downlink MAC message.

In one aspect, the second modulation scheme is selected to obtain an optimized payload size of at least one uplink RLC or uplink MAC message. The payload size may be optimized when padding of the payload is minimized.

Other aspects, embodiments, and features within the scope of the present disclosure will become apparent to those of ordinary skill in the art upon reviewing the following detailed description.

### BRIEF DESCRIPTION OF THE DRAWINGS

FIG. 1 is a conceptual diagram illustrating an example of an access network.

FIG. 2 is a block diagram conceptually illustrating an example Node B in communication with a UE in a telecommunications system.

FIG. 3 is a block diagram illustrating an example of a hardware implementation for an apparatus employing a processing system.

FIG. 4 is a block diagram illustrating an example of a telecommunications system configured according to certain aspects described herein.

FIG. 5 illustrates examples of different rate adaptation algorithms.

FIG. 6 is a flow diagram illustrating a method operational on a base station according to at least one example.

FIG. 7 is a block diagram illustrating an example of a base station according to one or more aspects of the disclosure.

FIG. 8 is a flow diagram illustrating a method operational on a base station according to at least one example.

FIG. 9 is a block diagram illustrating components of an access terminal according to at least one example.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

The various concepts presented throughout this disclosure may be implemented across a broad variety of telecommunication systems, network architectures, and communication standards. Certain aspects of the discussions are described below in relation to Global System for Mobile Communications (GSM), and in relation to 3rd Generation Partnership Project (3GPP) protocols and systems, and related terminology may be found in much of the following description. However, those of ordinary skill in the art will recognize that one or more aspects of the present disclosure may be employed and included in one or more other wireless communication protocols and systems.

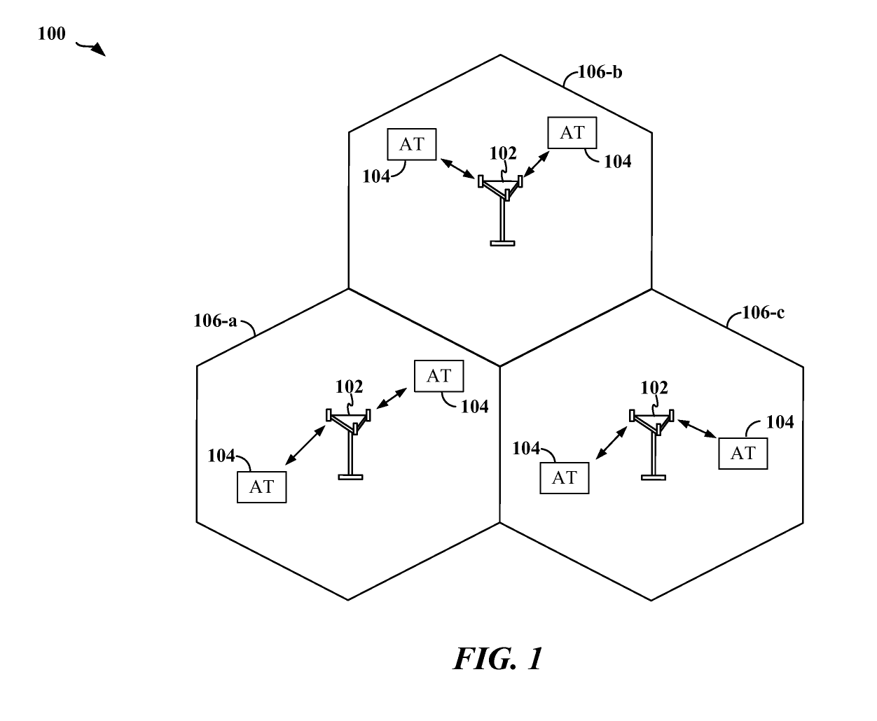

FIG. 1 is a block diagram of a network environment in which one or more aspects of the present disclosure may find application. The wireless communications system 100 includes base stations 102 adapted to communicate wirelessly with one or more access terminals 104. The system 100 may support operation on multiple carriers (waveform signals of different frequencies). Multi-carrier transmitters can transmit modulated signals simultaneously on the multiple carriers. Each modulated signal may be a CDMA signal, a TDMA signal, an OFDMA signal, a Single Carrier Frequency Division Multiple Access (SC-FDMA) signal, etc. Each modulated signal may be sent on a different carrier and may carry control information (e.g., pilot signals), overhead information, data, etc.

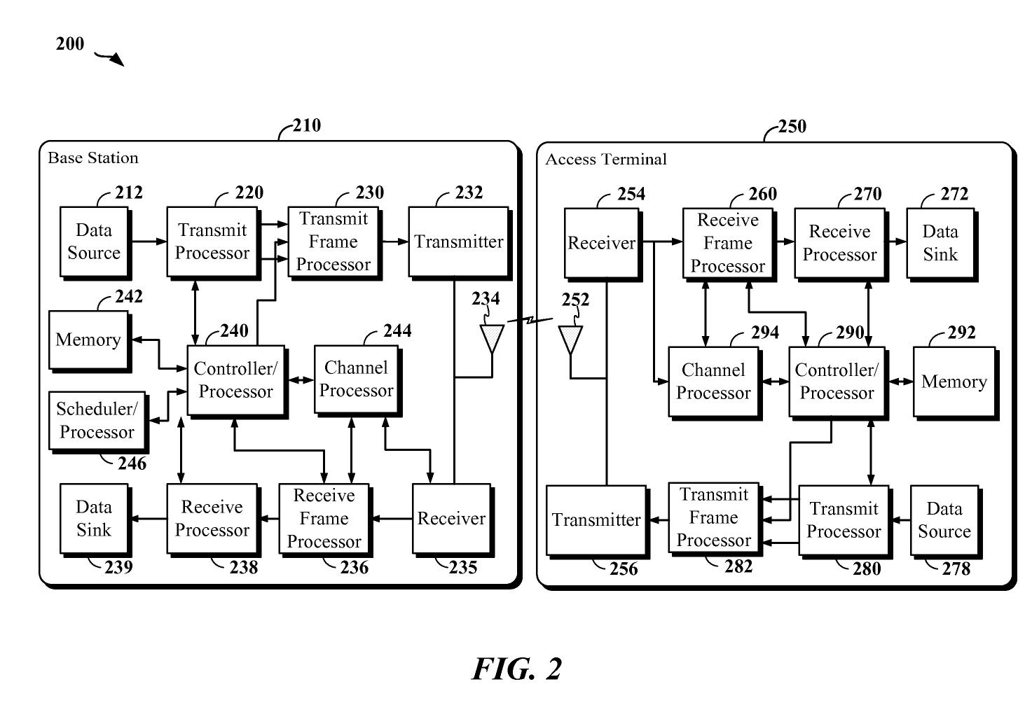

The base stations 102 can wirelessly communicate with the access terminals 104 via a base station antenna. The base stations 102 may each be implemented generally as a device adapted to facilitate wireless connectivity (for one or more access terminals 104) to the wireless communications system 100. The base stations 102 are configured to communicate with the access terminals 104 under the control of a base station controller (see FIG. 2) via multiple carriers. Each of the base station 102 sites can provide communication coverage for a respective geographic area. The coverage area 106 for each base station 102 here is identified as cells 106-a, 106-b, or 106-c. The coverage area 106 for a base station 102 may be divided into sectors (not shown, but making up only a portion of the coverage area). The system 100 may include base stations 102 of different types (e.g., macro, micro, and/or pico base stations).

One or more access terminals 104 may be dispersed throughout the coverage areas 106. Each access terminal 104 may communicate with one or more base stations 102. An access terminal 104 may generally include one or more devices that communicate with one or more other devices through wireless signals. Such an access terminal 104 may also be referred to by those skilled in the art as a user equipment (UE), a mobile station (MS), a subscriber station, a mobile unit, a subscriber unit, a wireless unit, a remote unit, a mobile device, a wireless device, a wireless communications device, a remote device, a mobile subscriber station, a mobile terminal, a wireless terminal, a remote terminal, a handset, a terminal, a user agent, a mobile client, a client, or some other suitable terminology. An access terminal 104 may include a mobile terminal and/or an at least substantially fixed terminal. Examples of an access terminal 104 include a mobile phone, a pager, a wireless modem, a personal digital assistant, a personal information manager (PIM), a personal media player, a palmtop computer, a laptop computer, a tablet computer, a notebook, a netbook, a smartbook, a personal digital assistant (PDA), a satellite radio, a global positioning system (GPS) device, a multimedia device, a video device, a digital audio player (e.g., MP3 player), a camera, a game console, wearable computing device (e.g., a smartwatch, a health or fitness tracker, etc.), a television, an appliance, an e-reader, a digital video recorder (DVR), a machine-to-machine (M2M) device, an entertainment device, a vehicle component, and/or other communication/computing device which communicates, at least partially, through a wireless or cellular network.

FIG. 2 is a block diagram of an exemplary base station 210 in communication with an exemplary access terminal 250, where the base station 210 may be the Base Station 104 in FIG. 1, and the access terminal 250 may be the access terminal 104 in FIG. 1. In the downlink communication, a transmit processor 220 may receive data from a data source 212 and control signals from a controller/processor 240. The transmit processor 220 provides various signal processing functions for the data and control signals, as well as reference signals (e.g., pilot signals). For example, the transmit processor 220 may provide cyclic redundancy check (CRC) codes for error detection, coding and interleaving to facilitate forward error correction (FEC), mapping to signal constellations based on various modulation schemes (e.g., binary phase-shift keying (BPSK), QPSK, M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 244 may be used by a controller/processor 240 to determine the coding, modulation, spreading, and/or scrambling schemes for the transmit processor 220. These channel estimates may be derived from a reference signal transmitted by the access terminal 250 or from feedback from the access terminal 250. The symbols generated by the transmit processor 220 are provided to a transmit frame processor 230 to create a frame structure. The transmit frame processor 230 creates this frame structure by multiplexing the symbols with information from the controller/processor 240, resulting in a series of frames. The frames are then provided to a transmitter 232, which provides various signal conditioning functions including amplifying, filtering, and modulating the frames onto a carrier for downlink transmission over the wireless medium through antenna 234. The antenna 234 may include one or more antennas, for example, including beam steering bidirectional adaptive antenna arrays or other similar beam technologies.

At the access terminal 250, a receiver 254 receives the downlink transmission through an antenna 252 and processes the transmission to recover the information modulated onto the carrier. The information recovered by the receiver 254 is provided to a receive frame processor 260, which parses each frame, and provides information from the frames to a channel processor 294 and the data, control, and reference signals to a receive processor 270. The receive processor 270 then performs the inverse of the processing performed by the transmit processor 220 in the base station 210. More specifically, the receive processor 270 descrambles and despreads the symbols, and then determines the most likely signal constellation points transmitted by the base station 210 based on the modulation scheme. These soft decisions may be based on channel estimates computed by the channel processor 294. The soft decisions are then decoded and deinterleaved to recover the data, control, and reference signals. The CRC codes are then checked to determine whether the frames were successfully decoded. The data carried by the successfully decoded frames will then be provided to a data sink 272, which represents applications running in the access terminal 250 and/or various user interfaces (e.g., display). Control signals carried by successfully decoded frames will be provided to a controller/processor 290. When frames are unsuccessfully decoded by the receiver processor 270, the controller/processor 290 may also use an acknowledgement (ACK) and/or negative acknowledgement (NACK) protocol to support retransmission requests for those frames.

On the uplink, data from a data source 278 and control signals from the controller/processor 290 are provided to a transmit processor 280. The data source 278 may represent applications running in the access terminal 250 and various user interfaces (e.g., keyboard). Similar to the functionality described in connection with the downlink transmission by the base station 210, the transmit processor 280 provides various signal processing functions including CRC codes, coding and interleaving to facilitate FEC, mapping to signal constellations, spreading with OVSFs, and scrambling to produce a series of symbols. Channel estimates, derived by the channel processor 294 from a reference signal transmitted by the base station 210 or from feedback contained in the midamble transmitted by the base station 210, may be used to select the appropriate coding, modulation, spreading, and/or scrambling schemes. The symbols produced by the transmit processor 280 will be provided to a transmit frame processor 282 to create a frame structure. The transmit frame processor 282 creates this frame structure by multiplexing the symbols with information from the controller/processor 290, resulting in a series of frames. The frames are then provided to a transmitter 256, which provides various signal conditioning functions including amplification, filtering, and modulating the frames onto a carrier for uplink transmission over the wireless medium through the antenna 252.

The uplink transmission is processed at the base station 210 in a manner similar to that described in connection with the receiver function at the access terminal 250. A receiver 235 receives the uplink transmission through the antenna 234 and processes the transmission to recover the information modulated onto the carrier. The information recovered by the receiver 235 is provided to a receive frame processor 236, which parses each frame, and provides information from the frames to the channel processor 244 and the data, control, and reference signals to a receive processor 238. The receive processor 238 performs the inverse of the processing performed by the transmit processor 280 in the access terminal 250. The data and control signals carried by the successfully decoded frames may then be provided to a data sink 239 and the controller/processor, respectively. If some of the frames were unsuccessfully decoded by the receive processor, the controller/processor 240 may also use an acknowledgement (ACK) and/or negative acknowledgement (NACK) protocol to support retransmission requests for those frames.

The controller/processors 240 and 290 may be used to direct the operation at the base station 210 and the access terminal 250, respectively. For example, the controller/processors 240 and 290 may provide various functions including timing, peripheral interfaces, voltage regulation, power management, and other control functions. The computer readable media of memories 242 and 292 may store data and software for the base station 210 and the access terminal 250, respectively. A scheduler/processor 246 at the base station 210 may be used to allocate resources to the access terminals 250 and schedule downlink and/or uplink transmissions for the access terminals 250.

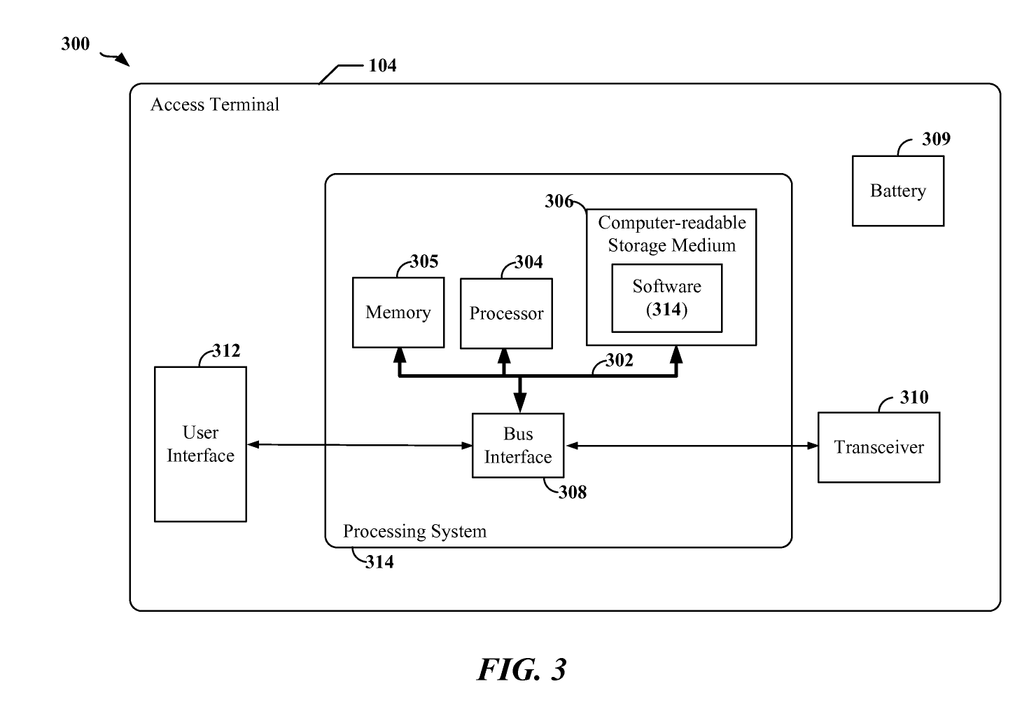

FIG. 3 is a block diagram illustrating a simplified example of a hardware implementation for an apparatus, which may be an access terminal 104 or base station 102, and which employs a processing system 314. In accordance with various aspects of the disclosure, an element, or any portion of an element, or any combination of elements may be implemented with a processing system 314 that includes one or more processors 304. Examples of processors 304 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

In this example, the processing system 314 may be implemented with a bus architecture, represented generally by the bus 302. The bus 302 may include any number of interconnecting buses and bridges depending on the specific application of the processing system 314 and the overall design constraints. The bus 302 links together various circuits or components including one or more processors (represented generally by the processor 304), a memory 305, computer-readable media (represented generally by the computer-readable medium 306). The bus 302 may also link various other circuits such as timing sources, peripherals, voltage regulators, and power management circuits, which are well known in the art, and therefore, will not be described any further. A bus interface 308 provides an interface between the bus 302 and one or more transceivers 310. The one or more transceivers 310 provide a means for communicating with various other apparatus over a transmission medium. The access terminal 104 also includes a battery 309 for powering various components such as the one or more transceivers 310 of the access terminal 104.

Depending upon the nature of the apparatus, a user interface 312 (e.g., keypad, display, speaker, microphone, joystick) may also be provided. The processor 304 is responsible for managing the bus 302 and general processing, including the execution of software 314 stored on the computer-readable medium 306. The software 314, when executed by the processor 304, causes the processing system 314 to perform the various functions described infra for any particular apparatus. For example, the software 314 may include code for implementing a modified page read schedule. The computer-readable medium 306 may also be used for storing data that is manipulated by the processor 304 when executing software.

One or more processors 304 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 306. The computer-readable medium 306 may be non-transitory. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 306 may reside in the processing system 314, external to the processing system 314, or distributed across multiple entities including the processing system 314. The computer-readable medium 306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

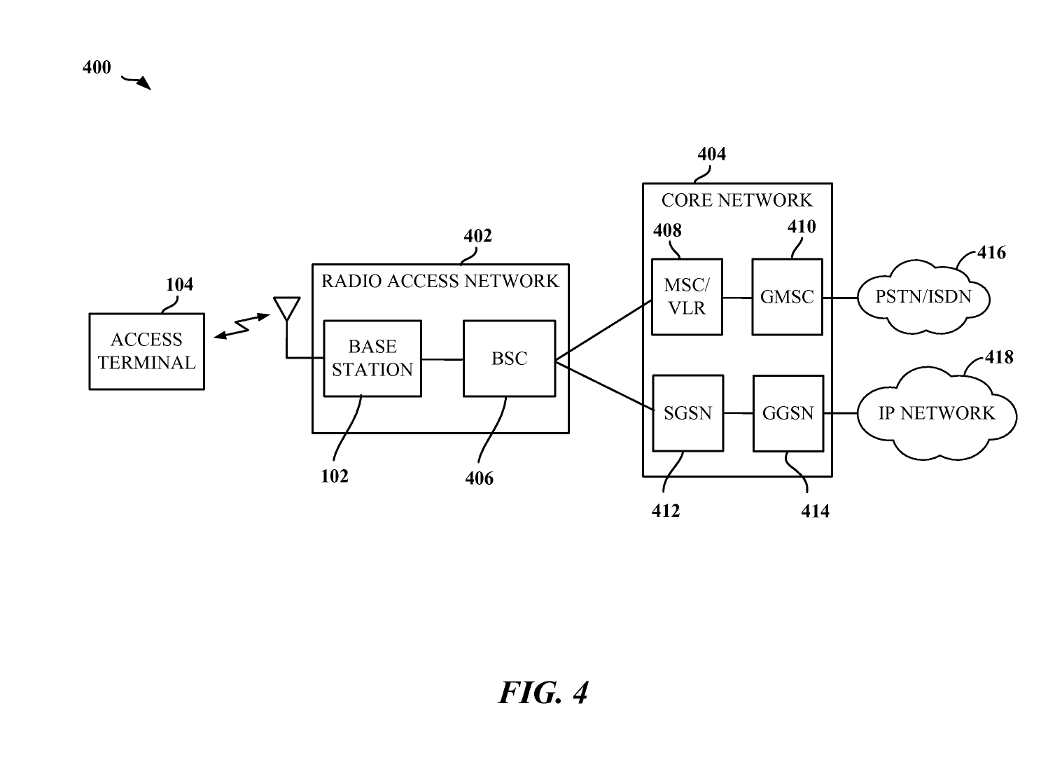

FIG. 4 is a block diagram 400 illustrating certain components of a wireless communication system 100 in accordance with certain aspects disclosed herein. As illustrated, one or more base stations 102 are included as a part of a radio access network (RAN) 402. The radio access network (RAN) 402 is generally adapted to manage traffic and signaling between one or more access terminals 104 and one or more other network entities, such as network entities included in a core network 404. The RAN 402 may, according to various implementations, be referred to by those skill in the art as a base station subsystem (BSS), an access network, etc.

In addition to one or more base stations 102, the radio access network 402 may include a base station controller (BSC) 406, which may also be referred to by those of skill in the art as a radio network controller (RNC). The BSC 406 is generally responsible for the establishment, release, and maintenance of wireless connections within one or more coverage areas associated with the one or more base stations 102 that are connected to the BSC 406. The BSC 406 can be communicatively coupled to one or more nodes or entities of the core network 404.

The core network 404 may be a portion of the wireless communications system 100 that provides various services to access terminals 104 that are connected via the RAN 402. The core network 404 may include a circuit-switched (CS) domain and a packet-switched (PS) domain. Some examples of CS entities include a mobile switching center (MSC) and visitor location register (VLR), identified as MSC/VLR 408, as well as a Gateway MSC (GMSC) 410. A PS domain may be implemented using general packet radio service (GPRS) on second generation (2G) GSM and third generation (3G) UMTS networks. Some examples of packet-switched elements include a Serving GPRS Support Node (SGSN) 412 and a Gateway GPRS Support Node (GGSN) 414. Other network entities may be included, such as an Equipment Identity Register (EIR), Home Location Register (HLR) and an Authentication Center (AuC), some or all of which may be shared by both the CS domain and the PS domain. An access terminal 104 can obtain access to a public switched telephone network (PSTN) 416 via the CS domain, and to an IP network 418 via the PS domain.

Certain RANs employ Enhanced GPRS (EGPRS) to provide improved data transmission rates for certain types of data communication. EGPRS may also be referred to as Enhanced Data rates for GSM Evolution (Edge). Edge/EGPRS may be deployed as a backward-compatible extension of GSM in a GSM Edge Radio Access Network (GERAN), for example. EGPRS can be used to support various PS applications, including Internet-based applications. EGPRS can use a higher-order phase-shift keying (PSK), including PSK/8, for at least five available modulation and coding schemes (MCSs), which may be identified as MCS-5 to MCS-9. PSK is a digital modulation scheme that conveys data by changing, or modulating, the phase of a carrier. PSK/8 schemes use quadrature amplitude modulation (QAM) to encode 4 bits per symbol (16-QAM) or 5 bits per symbol (32-QAM). MCS-5 through MCS-9 typically use 16-QAM, while MCS-10 through MCS-12 may use 32-QAM. Four lower-order MCSs may be provided as the four lower bitrate MCS-1 to MCS-4. In EGPRS the MCS-1 to MCS-4 schemes may use GMSK, which is a frequency shift keying modulation scheme that can be used in order to avoid phase discontinuities and to avoid non-linear distortion under certain operating conditions.

Control information may be exchanged in media access control (MAC) and Radio Link Control (RLC) messages. In conventional systems, uplink and/or downlink transmissions carrying MAC control messages are sent using one predefined coding and modulation scheme. That is, MAC messages are conventionally transmitted using a predefined channel coding scheme, which may be MCS-1. In some instances, a wireless communications apparatus may be restricted to transmitting RLC messages in the MCS-1 coding scheme. MCS-1 operates at a relatively low bit rate in comparison to other MCSs. MCS-1 may be more reliable and less susceptible to interference than other higher bit rate modulation and coding schemes. MCS-1 may support a bit rate of 8.8 kbits per second per transmission slot while MCS-2 can support a bit rate of 11.2 kbits per second per transmission slot and MCS-9 can support a bit rate of 59.2 kbits per second per transmission slot. In one example, MCS-1 offers a maximum payload size of approximately 22 octets. However, some control messages may exceed the 22 octet limit of MCS-1 and increasing amounts of information may need to be sent in control messages as available resources increase. For example, an access terminal may be required to report on greater numbers of frequencies, carriers, etc., and the resulting reporting data may often be increased by factors of 4, 8, and 16 for different timeslots.

In one approach, increased volume of control messages may be handled through segmentation and re-assembly of downlink MAC messages and/or RLC messages. This allows downlink MAC messages and/or RLC messages to be segmented into two or more blocks, with each block being sent separately. Segmentation and reassembly may provide a satisfactory solution for transmitting infrequent downlink messages; however, segmentation and reassembly is typically inadequate and/or unacceptable for uplink control messages and for implementations in which frequent downlink messages are transmitted. Uplink control messages often carry time-sensitive information related to the downlink channel conditions including, for example, acknowledgement and/or negative-acknowledgement (ACK/NACK) messages, radio frequency (RF) power levels measured by an access terminal, signal-to-noise ratio for different modulation schemes, power levels of interfering signals, and so on. When the downlink is limited to a single carrier, MAC messages and/or RLC messages may fit within the size limitation on control messages imposed by the low data rate of MCS-1 encoding. However, when multiple downlink carriers are used, the access terminal may be required to report significantly more information. Delays in reporting the information can result when multiple uplink control messages are used to report this increased information, and the network may receive the information too late to facilitate efficient network operations.

According to certain aspects described herein, base stations 102 and access terminals 104 can be configured to encode MAC messages and/or RLC messages using an MCS other than MCS-1 on either or both of the uplink and the downlink. For example, uplink and/or downlink transmissions carrying MAC control messages may select an MCS other than the predefined modulation scheme for MAC control messages, where the modulation scheme may be selected based on measured or reported radio conditions. The use of a different MCS can increase the information-carrying capacity of EGPRS control channels. One or more additional modulation and/or channel coding schemes can be defined for use with transmission of MAC messages and/or RLC messages, and the transmitter can select the most appropriate modulation and channel coding scheme to carry the MAC messages and/or RLC messages based on radio conditions measured by the access terminal 104. The access terminal 104 and RAN 402 can exchange information to determine which modulation and channel coding schemes can be used for transmitting MAC messages and/or RLC messages, and if a higher-order MCS may be used in addition to legacy MCS options.

According to certain aspects described herein, link adaptation techniques may be employed to select an MCS to be used for communicating MAC messages and/or RLC messages. The encoding scheme may be selected based on current RF channel conditions measured by the access terminal 104. Link adaptation, or adaptive modulation and coding (AMC), is employed in GERANs to match modulation, coding and other signal and protocol parameters to conditions observed on the radio link, when communicating user data. Link conditions may be characterized by the network geometry and power of received signals, including carriers and interfering signals as measured at the receiver. Link conditions may be expressed as some combination of path loss, interference due to signals received from other transmitters, sensitivity of the receiver, and available transmitter power margin for the access terminal.

According to one or more aspects disclosed herein, certain link adaptation methods employed for user data may be adapted for use in selecting a best available MCS for MAC messages and/or RLC messages on the uplink and downlink. The best available MCS may provide a highest bit-rate while maintaining a minimum desired reliability for transmitting MAC messages and/or RLC messages. The minimum reliability may be calculated as a maximum number of retransmits within a time-period, for example. One or more of the rate adaptation algorithms may be modified or configured to accommodate requirements associated with the transmission of MAC messages and/or RLC messages including, for example, requirements related to bit rates and levels of robustness of data transmission. For example, a high level of robustness is typically desired for communicating control information. The rate adaptation algorithms may be configured and optimized to account for the type of information to be transmitted, in addition to current channel conditions. In some instances, a rate adaptation algorithm that selects an MCS for transmitting MAC messages and/or RLC messages may be less responsive to improvements in channel conditions than an algorithm that selects an MCS for transmitting user data. In some instances, a rate adaptation algorithm that selects an MCS for transmitting control information may be more reactive to degradation of channel conditions than an algorithm that selects an MCS for transmitting user data.

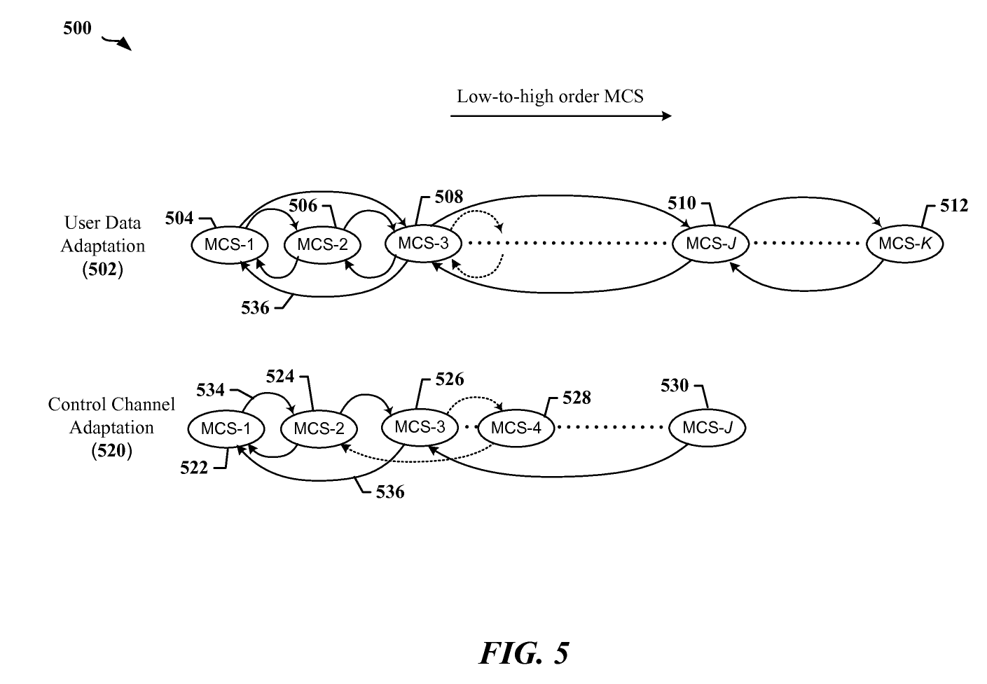

FIG. 5 is a drawing 500 that illustrates examples of different rate adaptation algorithms 502, 520 that may be employed to select MCSs for user data and control information. The user data rate adaptation algorithm 502 may be used to select a current MCS from a plurality of MCSs 504, 506, 508, 510, 512, including a low order MCS-1 504 up to a high order MCS-K 512. In one example, the control channel rate adaptation algorithm 520 may be used to select a current MCS from fewer MCSs 522, 524, 526, 528, 530, including the low order MCS-5 522 and up to a highest-order MCS-J 530. The restriction to a highest-order MCS 530 may be imposed when the reliability of higher bit rate MCSs (e.g. MCS-K 512) falls below minimum threshold levels under a high percentage of operating conditions.

The reactiveness of the control channel rate adaptation algorithm 520 may be further limited with respect to the reactiveness of the user data channel rate adaptation algorithm 502 by limiting the rate and magnitude of each increase 534 in MCS order. For example, the control channel rate adaptation algorithm 520 may select a next level MCS after a predefined number of measurements which indicate that the channel can support reliable communication using the next MCS. The next level MCS selected may be a one-step increase 534 in MCS order (e.g. MCS-3 526 to MCS-5 528). Meanwhile, the user data channel rate adaptation algorithm 502 may increase bit rate more rapidly by selecting a new MCS after fewer measurements, and by selecting an MCS based on channel condition rather than stepping up through the intervening MCSs.

The control channel rate adaptation algorithm 520 may be more reactive than the user data channel rate adaptation algorithm 502 under deteriorating channel conditions. That is, the control channel rate adaptation algorithm 520 may fallback more rapidly and in fewer steps than the user data channel rate adaptation algorithm 502.

A rate adaptation algorithm configured to select an MCS for control information may provide a lower data rate than an MCS selected for user data under the same link conditions. User data can typically tolerate some dropped packets for certain low-latency applications such as video or voice over IP, and can withstand delays associated with retransmissions for applications that require low data-loss. However, reliable operation of the RAN typically requires that MAC messages and/or RLC messages be delivered reliably with low data-loss and without significant delay. For example, MAC messages and/or RLC messages used to transmit link condition measurements may have a useful lifetime of 2 milliseconds or less in an EGPRS network. Delays in delivery of the MAC messages and/or RLC messages or failure to deliver the MAC messages and/or RLC messages may result in the selection of an MCS for a radio link that does not have sufficient quality to reliably support expected data rates.

According to certain aspects disclosed herein, a rate adaptation algorithm that is used to select an MCS for encoding and modulating uplink and downlink user data may be configured, adapted, or otherwise modified to select an MCS for encoding and/or modulating uplink or downlink control information. Additionally or alternatively, a less aggressive algorithm may be used to select an MCS to encode or modulate uplink or downlink MAC messages and/or RLC messages, such that a transmitting communications device can set a more conservative expectation of data rates for control messages than for user data. In one example, the rate adaptation algorithm may determine a first MCS for encoding and transmitting user data based on a first set of criteria that produce a higher data rate than a second MCS identified by the rate adaptation algorithm for encoding or modulating uplink or downlink MAC messages and/or RLC messages. A second set of criteria may be used for selecting the second MCS, where the parameters are adjusted to obtain a more reliable transmission encoding scheme for the control messages. Increased reliability may be associated with decreased data rates.

In one example, the rate adaptation algorithm may be adapted by modifying one or more threshold values used to determine, assess or otherwise characterize link quality. The threshold values may include a maximum permissible Signal to Interference plus Noise Ratio (SINR), a minimum available transmitter power, and/or a maximum permissible path loss. One or more of the threshold values may be separately configured for each MCS selection process. Thus, for example, a measured SINR may exceed a first threshold, causing the selection of a first MCS associated with a relatively high data rate for user data, while the measured SINR may not exceed a second, higher threshold configured for selecting a second MCS for control data and a second MCS may be selected that provides a relatively low data rate. In the latter example, it can be expected that the reliability of the second MCS is greater than the first MCS.

In another example, the rate adaptation algorithm may be adapted by implementing different selection processes for user data and control messages based on a common assessment of channel conditions. In this example, a single set of threshold values may be used to determine, assess, or otherwise characterize link quality. The selection process for an MCS for use with control information may interpret the assessment of channel conditions differently than the selection process for an MCS for use with user data.

Indeed, a rate adaptation algorithm may first select an MCS for user data transmission, and the same rate adaptation algorithm or a different rate adaptation algorithm may select an MCS for MAC messages and/or RLC messages that has a lower data rate than the data rate associated with the MCS selected for user data transmission. For example, if MCS-8 is selected for transmitting user data, then any of MCS-1 through MCS-7 may be selected for MAC messages and/or RLC message transmission. The choice between MCS-1 through MCS-7 may include a consideration of history of prior channel conditions, variations in channel conditions, longevity of the current channel conditions, and other temporal aspects and variations in channel condition. The choice between MCS-1 through MCS-7 may additionally or alternatively be based on a predefined step difference between MCS levels selected for data transmission and for sending control messages. The choice between MCS-1 through MCS-7 may additionally or alternatively be based on a type of network, a type or quality-of-service defined for the user data and on other characteristics related to RAN 402, radio access technology or the access terminal 104.

According to certain aspects disclosed herein, the rate adaptation algorithm used to select an MCS for encoding and modulating uplink and downlink user data may be configured to consider the age of measurements used to select an MCS for encoding or modulating uplink or downlink MAC messages and/or RLC messages. For example, a base station 102 may select a lower data rate MCS if an RF link measurement report is not timely received, based on the assumption that a degraded link has caused loss of data.

According to certain aspects disclosed herein, a receiving communications device, such as a base station 102 or an access terminal 104, may be configured for blind detection of the MCS used for encoding and modulating received MAC messages and/or RLC messages. That is, the devices 102, 104 adapted according to one or more aspects of the disclosure may be required to dynamically identify the MCS used by a transmitter for encoding MAC messages and/or RLC messages, whereas conventional devices may assume that the lowest available data-rate MCS is used for transmitting MAC messages and/or RLC messages. In some instances, MAC messages and/or RLC messages are transmitted by the base station 102 or access terminal 104 in a 4-frame burst that includes a training sequence. The training sequence includes symbols that rotate according to the type of modulation scheme used. For example, GMSK may have symbols that rotate by 90 degrees between symbols, while a PSK scheme may have symbols that rotate by 45 degrees between symbols. In one example, the MCS used for encoding the MAC messages and/or RLC messages can be determined from symbol rotation in the training sequence preceding MAC messages and/or RLC messages. The information obtained from the training sequences can be used to determine the demodulating and decoding schemes to be employed for the MAC messages and/or RLC messages.

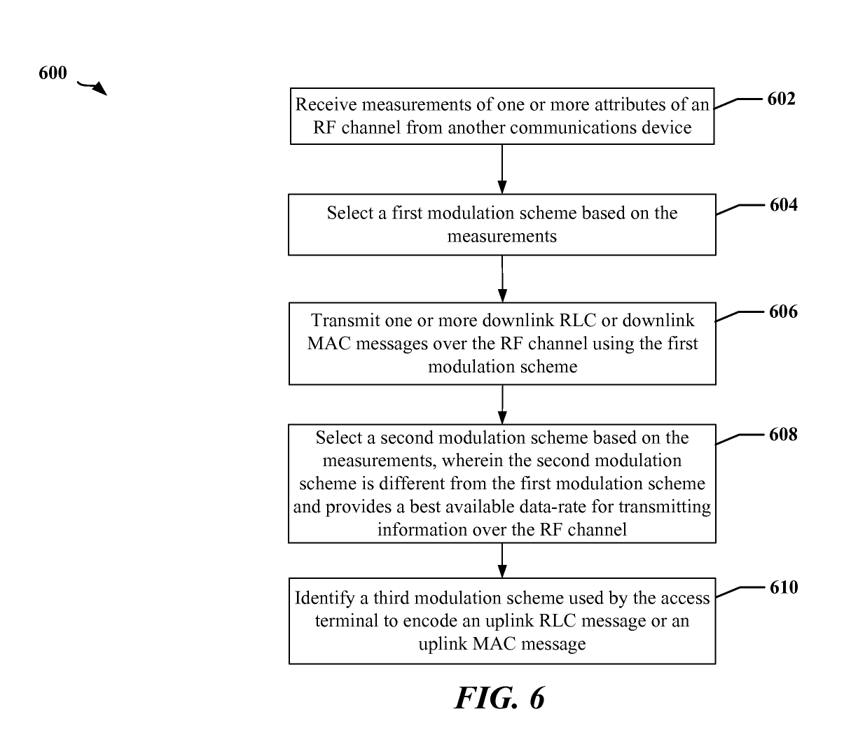

According to at least one aspect of the present disclosure, methods operational on a base station are provided for increasing information carrying capacity of an EGPRS control channel. FIG. 6 is a flow diagram 600 illustrating a method operational in a communications interface that may be, for example, a base station such as base station 102, in accordance with certain aspects disclosed herein.

At 602, the base station 102 may receive measurements of one or more attributes of an RF channel from another communications device. The latter communications device may be an access terminal 104, for example.

At 604, the base station 102 may select a first modulation scheme based on the measurements. The first modulation scheme may provide a best available data-rate for transmitting information over the RF channel. The first modulation scheme may be defined by one of a plurality of available MCS schemes.

At 606, the base station 102 may transmit one or more downlink RLC or downlink MAC messages over the RF channel 104 using the first modulation scheme.

At 608, the base station 102 may select a second modulation scheme based on the measurements. The second modulation scheme may be different from the first modulation scheme. The second modulation scheme may provide a higher transmission bit rate than the first modulation scheme. The second modulation scheme may provide a best available data-rate for transmitting information over the RF channel. The second modulation scheme may be used for transmitting user data over the RF channel.

In an aspect of the disclosure, the base station 102 may select the first modulation scheme based on a link quality of the RF channel determined by comparing the measurements to a first set of threshold values. The base station 102 may select a second modulation scheme based on a link quality of the RF channel determined by comparing the measurements to a second set of threshold values that is different from the first set of threshold values. The first set of threshold values and the second set of threshold values may relate to different maximum permissible SINRs, different minimum available transmitter powers, or different maximum permissible path losses.

In an aspect of the disclosure, the base station 102 may determine a link quality of the RF channel based on the measurements, select the first modulation scheme by comparing the link quality to a first set of criteria, and select a second modulation scheme by comparing the link quality to a second set of criteria that is different from the first set of criteria. The second modulation scheme may be used for transmitting user data over the RF channel. The first set of criteria and the second set of criteria may relate to a maximum permissible SINR, a minimum available transmitter power, or a maximum permissible path loss.

In an aspect of the disclosure, the base station 102 may determine a link quality of the RF channel based on the measurements, select a second modulation scheme based on the link quality, select a modulation scheme that provides a lower data-rate than the second modulation scheme as the first modulation scheme when the second modulation scheme does not provide a lowest available data-rate for transmitting information over the RF channel, and select a modulation scheme that provides the same data-rate as the second modulation scheme as the first modulation scheme when the second modulation scheme provides the lowest available data-rate for transmitting information over the RF channel to the access terminal. The second modulation scheme may provide a best available data-rate for transmitting information over the RF channel to the access terminal 104.

In an aspect of the disclosure, the RF channel is an EGPRS control channel.

In an aspect of the disclosure, the first modulation scheme employs a phase-shift keying modulation scheme. The first modulation scheme may be different from a default modulation scheme defined for encoding the one or more downlink RLC or downlink MAC messages. The first modulation scheme may be selected to obtain a desired payload size for at least one downlink RLC or downlink MAC message. The desired payload size may be optimized when padding of the payload is minimized.

At 610, the base station 102 may identify a third modulation scheme used by an access terminal 104 to encode an uplink RLC message or an uplink MAC message, and decode the uplink RLC message or the uplink MAC message based on the identification of the third modulation scheme. The third modulation scheme may be identified from a symbol rotation in a training sequence preceding the uplink RLC message or the uplink MAC message.

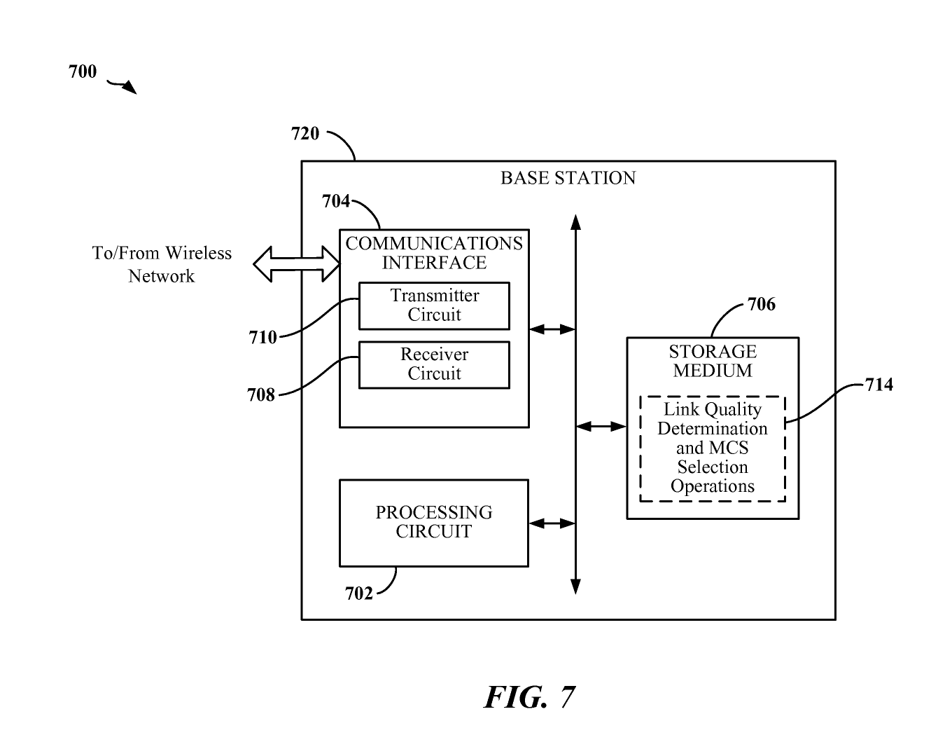

According to certain aspects of the present disclosure, an access terminal 104 or base station 102 may be adapted to increase information carrying capacity of an EGPRS control channel. For example, FIG. 7 is a block diagram 700 illustrating select components of a base station 720 according to at least one example. Here, the base station 720 may be utilized as the base station 102 described above and illustrated in FIGS. 1 and 2. As shown, the base station 720 may include a processing circuit 702 coupled to or placed in electrical communication with a communications interface 704 and a storage medium 706.

The processing circuit 702 is arranged to obtain, process and/or send data, control data access and storage, issue commands, and control other desired operations. The processing circuit 702 may include circuitry adapted to implement desired programming provided by appropriate storage media in at least one example. For example, the processing circuit 702 may be implemented as one or more processors, one or more controllers, and/or other structure configured to execute executable programming Examples of the processing circuit 702 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 702 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 702 are for illustration and other suitable configurations within the scope of the present disclosure are also contemplated.

The processing circuit 702 is adapted for processing, including the execution of programming, which may be stored on the storage medium 706. As used herein, the term “programming” shall be construed broadly to include without limitation instructions, instruction sets, data, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The communications interface 704 is configured to facilitate wireless communications of the access terminal 700. For example, the communications interface 704 may include circuitry and/or programming adapted to facilitate the communication of information bi-directionally with respect to one or more network nodes. The communications interface 704 may be coupled to one or more antennas (not shown), and includes wireless transceiver circuitry, including at least one receiver circuit 708 (e.g., one or more receiver chains) and/or at least one transmitter circuit 710 (e.g., one or more transmitter chains). By way of example and not limitation, the at least one receiver circuit 708 may include circuitry, devices and/or programming associated with a data path (e.g., antenna, amplifiers, filters, mixers) and with a frequency path (e.g., a phase-locked loop (PLL) component).

The storage medium 706 may represent one or more computer-readable, machine-readable, and/or processor-readable devices for storing programming, such as processor executable code or instructions (e.g., software, firmware), electronic data, databases, or other digital information. The storage medium 706 may also be used for storing data that is manipulated by the processing circuit 702 when executing programming. The storage medium 706 may be any available media that can be accessed by a general purpose or special purpose processor, including portable or fixed storage devices, optical storage devices, and various other mediums capable of storing, containing and/or carrying programming. By way of example and not limitation, the storage medium 706 may include a computer-readable, machine-readable, and/or processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof.

The storage medium 706 may be coupled to the processing circuit 702 such that the processing circuit 702 can read information from, and write information to, the storage medium 706. That is, the storage medium 706 can be coupled to the processing circuit 702 so that the storage medium 706 is at least accessible by the processing circuit 702, including examples where the storage medium 706 is integral to the processing circuit 702 and/or examples where the storage medium 706 is separate from the processing circuit 702 (e.g., resident in the access terminal 700, external to the access terminal 700, and/or distributed across multiple entities).

Programming stored by the storage medium 706, when executed by the processing circuit 702, causes the processing circuit 702 to perform one or more of the various functions and/or process steps described herein. For example, the storage medium 706 may include link quality determination and MCS selection operations 714. The link quality determination and MCS selection operations 714 can be implemented by the processing circuit 702 and/or by a processor in the communications interface 704. Thus, according to one or more aspects of the present disclosure, the processing circuit 702 is adapted to perform (in conjunction with the storage medium 706) any or all of the processes, functions, steps and/or routines for any or all of the access terminals 104 described herein. As used herein, the term “adapted” in relation to the processing circuit 702 may refer to the processing circuit 702 being one or more of configured, employed, implemented, and/or programmed (in conjunction with the storage medium 706) to perform a particular process, function, step and/or routine according to various features described herein.

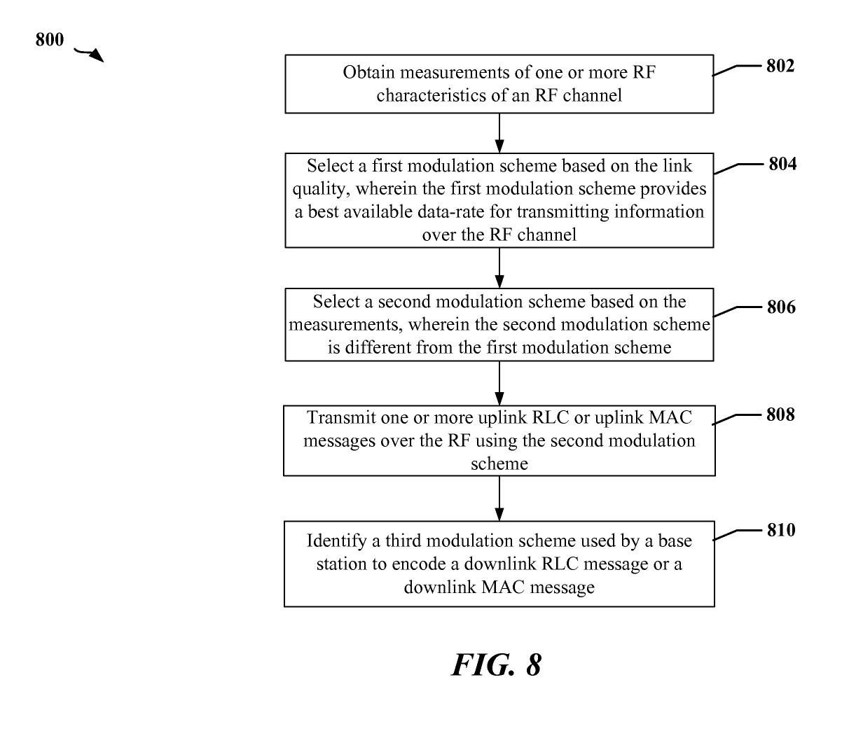

According to at least one aspect of the present disclosure, methods operational on an access terminal 104 are provided for increasing information carrying capacity of an EGPRS control channel. FIG. 8 is a flow diagram 800 illustrating a method operational in a communications interface that may be, for example an access terminal 104, in accordance with certain aspects disclosed herein.

At 802, the access terminal 104 may obtain measurements of one or more RF characteristics of an RF channel. The access terminal 104 may transmit the measurements to another communications device. In one example the other communications device is a base station 102.

At 804, the access terminal 104 may select a first modulation scheme based on the link quality. The first modulation scheme may provide a best available data-rate for transmitting information over the RF channel. The first modulation scheme may provide a best available data-rate for transmitting information over the RF channel.

The RF channel may include an EGPRS control channel.

At 806, the access terminal 104 may select a second modulation scheme based on the measurements. The second modulation scheme may be different from the first modulation scheme.

At 808, the access terminal 104 may transmit one or more uplink RLC or uplink MAC messages over the RF channel using the second modulation scheme.

In an aspect of the disclosure, the second modulation scheme used to encode the RLC message or the MAC message may be different from the first modulation scheme, which may be used to encode user data transmitted over the RF channel. The second modulation scheme may be different from a default modulation scheme defined for encoding the RLC message or the MAC message.

In an aspect of the disclosure, the access terminal 104 may select the first modulation scheme based on a first estimation of link quality of the RF channel determined by comparing the measurements to a first set of threshold values. The access terminal 104 may select the second modulation scheme based on a second estimation of link quality of the RF channel determined by comparing the measurements to a second set of threshold values that is different from the first set of threshold values. The first modulation scheme may be used for transmitting user data over the RF channel. The first set of threshold values and the second set of threshold values may relate to different maximum permissible SINRs, different minimum available transmitter powers, or different maximum permissible path losses.

In an aspect of the disclosure, the access terminal 104 may determine a link quality of the RF channel based on the measurements, select the first MCS by comparing the link quality to a first set of criteria, and select a second MCS by comparing the link quality to a second set of criteria that is different from the first set of criteria. The first MCS is used for transmitting user data over the RF channel. The first set of criteria and the second set of criteria relate to a maximum permissible SINR, a minimum available transmitter power, or a maximum permissible path loss.

In an aspect of the disclosure, the second modulation scheme may be selected to obtain an optimized payload size of at least one uplink RLC or uplink MAC message. The payload size may be optimized when padding of the payload is minimized.

At 810, the access terminal 104 may identify a third modulation scheme used by a base station 102 to encode a downlink RLC message or a downlink MAC message, and may decode the downlink RLC message or the downlink MAC message based on the identification of the third modulation scheme. The third modulation scheme may be identified from a symbol rotation in a training sequence preceding the downlink RLC message or the downlink MAC message.

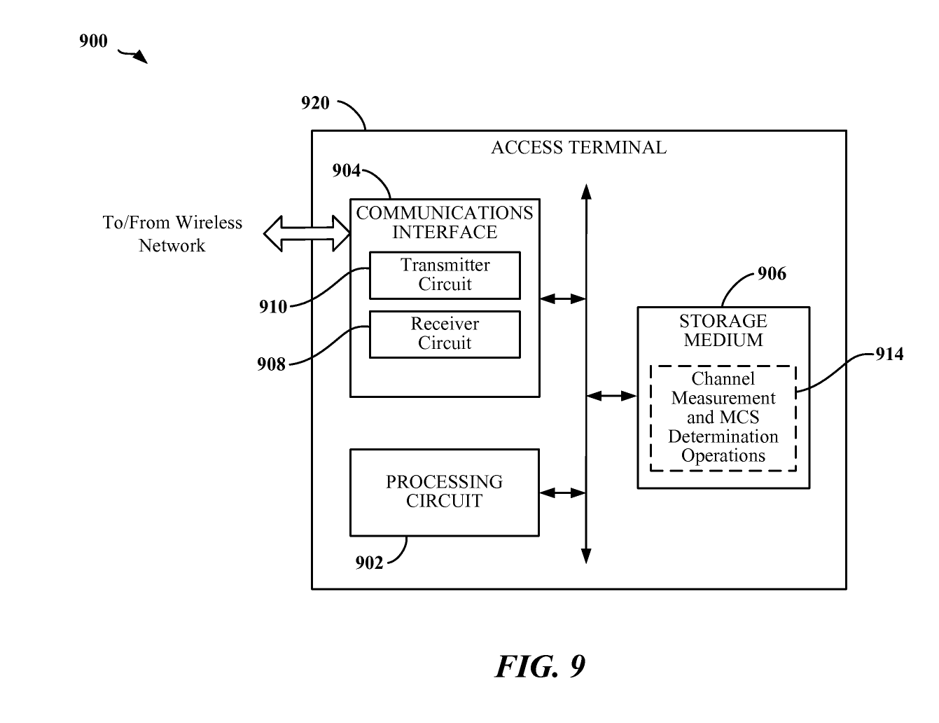

According to certain aspects of the present disclosure, an access terminal or base station may be adapted to increase information carrying capacity of an EGPRS control channel. For example, FIG. 9 is a block diagram 900 illustrating select components of an access terminal 920 according to at least one example. As shown, the access terminal 920 may include a processing circuit 902 coupled to or placed in electrical communication with a communications interface 904 and a storage medium 906.

The processing circuit 902 is arranged to obtain, process and/or send data, control data access and storage, issue commands, and control other desired operations. The processing circuit 902 may include circuitry adapted to implement desired programming provided by appropriate storage media in at least one example. For example, the processing circuit 902 may be implemented as one or more processors, one or more controllers, and/or other structure configured to execute executable programming Examples of the processing circuit 902 may include a general purpose processor, a DSP, an ASIC, an FPGA or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 902 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 902 are for illustration and other suitable configurations within the scope of the present disclosure are also contemplated.

The processing circuit 902 is adapted for processing, including the execution of programming, which may be stored on the storage medium 906. As used herein, the term “programming” shall be construed broadly to include without limitation instructions, instruction sets, data, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The communications interface 904 is configured to facilitate wireless communications of the access terminal 900. For example, the communications interface 904 may include circuitry and/or programming adapted to facilitate the communication of information bi-directionally with respect to one or more network nodes. The communications interface 904 may be coupled to one or more antennas (not shown), and includes wireless transceiver circuitry, including at least one receiver circuit 908 (e.g., one or more receiver chains) and/or at least one transmitter circuit 910 (e.g., one or more transmitter chains). By way of example and not limitation, the at least one receiver circuit 908 may include circuitry, devices and/or programming associated with a data path (e.g., antenna, amplifiers, filters, mixers) and with a frequency path (e.g., a PLL component).

The storage medium 906 may represent one or more computer-readable, machine-readable, and/or processor-readable devices for storing programming, such as processor executable code or instructions (e.g., software, firmware), electronic data, databases, or other digital information. The storage medium 906 may also be used for storing data that is manipulated by the processing circuit 902 when executing programming. The storage medium 906 may be any available media that can be accessed by a general purpose or special purpose processor, including portable or fixed storage devices, optical storage devices, and various other mediums capable of storing, containing and/or carrying programming. By way of example and not limitation, the storage medium 906 may include a computer-readable, machine-readable, and/or processor-readable storage medium such as a magnetic storage device (e.g., hard disk, floppy disk, magnetic strip), an optical storage medium (e.g., CD, DVD), a smart card, a flash memory device (e.g., card, stick, key drive), RAM, ROM, PROM, EPROM, electrically erasable EEPROM, a register, a removable disk, and/or other mediums for storing programming, as well as any combination thereof.

The storage medium 906 may be coupled to the processing circuit 902 such that the processing circuit 902 can read information from, and write information to, the storage medium 906. That is, the storage medium 906 can be coupled to the processing circuit 902 so that the storage medium 906 is at least accessible by the processing circuit 902, including examples where the storage medium 906 is integral to the processing circuit 902 and/or examples where the storage medium 906 is separate from the processing circuit 902 (e.g., resident in the access terminal 900, external to the access terminal 900, and/or distributed across multiple entities).

Programming stored by the storage medium 906, when executed by the processing circuit 902, causes the processing circuit 902 to perform one or more of the various functions and/or process steps described herein. For example, the storage medium 906 may include channel measurement and MCS determination operations 914. The channel measurement and MCS determination operations 914 can be implemented by the processing circuit 902 and/or by a decoder circuit 912 or processor in the communications interface 904. Thus, according to one or more aspects of the present disclosure, the processing circuit 902 is adapted to perform (in conjunction with the storage medium 906) any or all of the processes, functions, steps and/or routines for any or all of the access terminals 104 described herein. As used herein, the term “adapted” in relation to the processing circuit 902 may refer to the processing circuit 902 being one or more of configured, employed, implemented, and/or programmed (in conjunction with the storage medium 906) to perform a particular process, function, step and/or routine according to various features described herein.

While the above discussed aspects, arrangements, and embodiments are discussed with specific details and particularity, one or more of the components, steps, features and/or functions illustrated in FIGS. 1-9 may be rearranged and/or combined into a single component, step, feature or function or embodied in several components, steps, or functions. Additional elements, components, steps, and/or functions may also be added or not utilized without departing from the invention. The apparatus, devices and/or components illustrated in FIGS. 1-4, 7 and/or 9 may be configured to perform or employ one or more of the methods, features, parameters, or steps described in FIGS. 6 and 8. The novel algorithms described herein may also be efficiently implemented in software and/or embedded in hardware.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

We claim:

1. A base station, comprising:
a communications interface including a receiver circuit;
a storage medium; and
a processing circuit coupled to the communications interface and the storage medium, the processing circuit adapted to:
receive measurements of one or more attributes of a radio frequency (RF) channel from another communications device;
select a first modulation scheme based on the measurements; and
transmit one or more downlink media access control (MAC) messages over the RF channel using the first modulation scheme.

2. The base station of claim 1, wherein the processing circuit is adapted to:
select a second modulation scheme based on the measurements, wherein the second modulation scheme is used for transmitting user data over the RF channel.

3. The base station of claim 2, wherein the first modulation scheme provides a lower transmission bit rate than the second modulation scheme.

4. The base station of claim 1, wherein the processing circuit is adapted to:
select the first modulation scheme based on a link quality of the RF channel determined by comparing the measurements to a first set of threshold values; and
select a second modulation scheme based on a link quality of the RF channel determined by comparing the measurements to a second set of threshold values that is different from the first set of threshold values,
wherein the second modulation scheme is used for transmitting user data over the RF channel.

5. The base station of claim 4, wherein the first set of threshold values and the second set of threshold values define different maximum permissible Signal to Interference plus Noise Ratios (SINRs), different minimum available transmitter powers, or different maximum permissible path losses.

6. The base station of claim 1, wherein the processing circuit is adapted to:
determine a link quality of the RF channel based on the measurements;
select the first modulation scheme by comparing the link quality to a first set of criteria; and
select a second modulation scheme by comparing the link quality to a second set of criteria that is different from the first set of criteria,
wherein the second modulation scheme is used for transmitting user data over the RF channel.

7. The base station of claim 6, wherein the first set of criteria and the second set of criteria relate to a maximum permissible SINR, a minimum available transmitter power, or a maximum permissible path loss.

8. The base station of claim 1, wherein the processing circuit is adapted to:
determine a link quality of the RF channel based on the measurements;
select a second modulation scheme based on the link quality, wherein the second modulation scheme provides a best available data-rate for transmitting information over the RF channel;
select a modulation scheme that provides a lower data-rate than the second modulation scheme to be the first modulation scheme when the second modulation scheme does not provide a lowest available data-rate for transmitting information over the RF channel; and
select a modulation scheme that provides a same data-rate as the second modulation scheme to be the first modulation scheme when the second modulation scheme provides the lowest available data-rate for transmitting information over the RF channel,
wherein the second modulation scheme is used for transmitting user data over the RF channel.

9. The base station of claim 1, wherein the first modulation scheme employs a phase-shift keying modulation scheme.

10. The base station of claim 1, wherein the first modulation scheme is different from a default modulation scheme defined for encoding the one or more downlink MAC messages.

11. The base station of claim 1, wherein the first modulation scheme is selected to obtain a desired payload size for at least one downlink MAC message, and wherein the desired payload size is optimized when padding of the payload is minimized.

12. The base station of claim 1, wherein the processing circuit is adapted to:
identify a third modulation scheme that is used by an access terminal to encode an uplink MAC message; and
decode the uplink MAC message based on identification of the third modulation scheme.

13. The base station of claim 12, wherein the third modulation scheme is identified from a symbol rotation in a training sequence preceding the uplink MAC message.

14. A method for data communication performed by a base station, comprising:
receiving measurements of one or more attributes of a radio frequency (RF) channel from another communications device;
selecting a first modulation scheme based on the measurements; and
transmitting one or more downlink media access control (MAC) messages over the RF channel using the first modulation scheme.

15. The method of claim 14, further comprising:
selecting a second modulation scheme based on the measurements, wherein the second modulation scheme is different from the first modulation scheme and provides a best available data-rate for transmitting information over the RF channel; and
transmitting user data over the RF channel using the second modulation scheme,
wherein the first modulation scheme provides a lower transmission bit rate than the second modulation scheme.

16. The method of claim 14, further comprising:
identifying a third modulation scheme that is used by an access terminal to encode an uplink MAC message; and
decode the uplink MAC message based on the identification of the third modulation scheme,
wherein the third modulation scheme is identified from a symbol rotation in a training sequence preceding the uplink MAC message.

17. An access terminal, comprising:
a communications interface including a receiver circuit;
a storage medium; and
a processing circuit coupled to the communications interface and the storage medium, the processing circuit being adapted to:
cause the receiver circuit to obtain measurements of one or more radio frequency (RF) characteristics of an RF channel;
transmit the measurements to another communications device;
determine a first modulation scheme to be used to encode an uplink media access control (MAC) message for transmission on the RF channel based on the measurements; and
transmit the MAC message over the RF channel using the first modulation scheme.

18. The access terminal of claim 17, wherein the first modulation scheme is different from a second modulation scheme that is used to encode user data transmitted over the RF channel.

19. The access terminal of claim 17, wherein the first modulation scheme comprises a phase-shift keying modulation scheme, and wherein the first modulation scheme is different from a default modulation scheme defined for encoding the MAC message.

20. The access terminal of claim 17, wherein the processing circuit is adapted to:
select the first modulation scheme based on a link quality of the RF channel determined by comparing the measurements to a first set of threshold values; and
select a second modulation scheme based on a link quality of the RF channel determined by comparing the measurements to a second set of threshold values that is different from the first set of threshold values,
wherein the second modulation scheme is used for transmitting user data over the RF channel.

21. The access terminal of claim 20, wherein the first set of threshold values and the second set of threshold values define different maximum permissible Signal to Interference plus Noise Ratios (SINRs), different minimum available transmitter powers, or different maximum permissible path losses.

22. The access terminal of claim 17, wherein the processing circuit is adapted to:
determine a link quality of the RF channel based on the measurements;
select the first modulation scheme by comparing the link quality to a first set of criteria; and
select a second modulation scheme by comparing the link quality to a second set of criteria that is different from the first set of criteria,
wherein the second modulation scheme is used for transmitting user data over the RF channel.

23. The access terminal of claim 22, wherein the first set of criteria and the second set of criteria relate to a maximum permissible SINR, a minimum available transmitter power, or a maximum permissible path loss.

24. The access terminal of claim 17, wherein the first modulation scheme is selected to obtain an optimized payload size of at least one uplink MAC message, wherein the payload size is optimized when padding of the payload is minimized.

25. The access terminal of claim 17, wherein the processing circuit is adapted to:
identify a third modulation scheme that is used by a base station to encode a downlink RLC message or a downlink MAC message; and
decode the downlink MAC message based on identification of the third modulation scheme.

26. The access terminal of claim 25, wherein the third modulation scheme is identified from a symbol rotation in a training sequence preceding the downlink MAC message.

27. A method for data communication performed by an access terminal, comprising:
obtaining measurements of one or more radio frequency (RF) characteristics of an RF channel;
selecting a first modulation scheme based on the measurements, wherein the first modulation scheme provides a best available data-rate for transmitting information over the RF channel;
selecting a second modulation scheme based on the measurements, wherein the second modulation scheme is different from the first modulation scheme; and
transmitting one or more uplink media access control (MAC) messages over the RF channel using the second modulation scheme.

28. The method of claim 27, further comprising:
identifying a third modulation scheme that is used by a base station to encode a downlink MAC message; and
decode the downlink MAC message based on the identification of the third modulation scheme.

29. The method of claim 28, wherein the third modulation scheme is identified from a symbol rotation in a training sequence preceding the downlink MAC message.

30. The access terminal of claim 27, wherein the second modulation scheme is selected to obtain an optimized payload size of at least one uplink MAC message, wherein the payload size is optimized when padding of the payload is minimized.
